(19) United States
(12) Patent Application Publication
(10) Pub. No.: US 2025/0163747 A1
(43) Pub. Date: May 22, 2025

(54) POWER CLOSURE MEMBER SYSTEM HOLDING CURRENT SELF LEARNING

(71) Applicant: MAGNA CLOSURES INC., Newmarket (CA)

(72) Inventor: Antonio FRELLO, Newmarket (CA)

(21) Appl. No.: 18/938,969

(22) Filed: Nov. 6, 2024

Related U.S. Application Data
(60) Provisional application No. 63/599,828, filed on Nov. 16, 2023.

(51) Int. Cl. E05F 15/611; E05F 15/44; E05F 15/70

(52) U.S. Cl. CPC E05F 15/611; E05F 15/44; E05F 15/70; E05Y 2400/3015; E05Y 2400/356; E05Y 2400/415; E05Y 2900/531

(57) ABSTRACT

A power closure system for a vehicle and corresponding method of operation are provided. The system includes a door and a power actuator for moving the door between closed and open positions. The power actuator is adapted to output a holding force to hold the door at a hold position between the closed position and the open position. In addition, the power actuator is configured to output the holding force such that a force applied to the door by a user to overcome the holding force is substantially the same to move the door in either one of an opening direction and a closing direction.

### CROSS-REFERENCE TO RELATED APPLICATION

This application claims the benefit of U.S. Provisional Application No. 63/599,828 filed Nov. 16, 2023, the entire disclosure of which is incorporated herein by reference.

### FIELD

The present disclosure relates generally to closure systems for closure members of motor vehicles and, more particularly, to a power closure member actuation or power closure system for opening and closing doors of the motor vehicle automatically.

### BACKGROUND

This section provides background information related to the present disclosure which is not necessarily prior art.

A typical motor vehicle is equipped with at least one pair of doors to provide access to a passenger compartment. Specifically, most vehicles include driver-side and passenger-side swing doors that are pivotably supported from the vehicle body to move between closed and open positions. These doors are each equipped with a latch assembly having a latch mechanism operable in a latched mode to hold the door in its closed position and in an unlatched mode to permit movement of the door to its open position. The latch assembly is also equipped with a latch release mechanism that is selectively actuated (manually via a handle-actuated release system and/or via a power-operated release system) to shift the latch mechanism into its unlatched mode.

Many vehicles are equipped with multiple side (i.e., front and rear) doors for access to the passenger compartment. Most commonly, when viewed from the front of the vehicle 10, the front and rear side doors 12, 14 are hinged proximate their front edge to be moveable relative to a vehicle body 15 as best shown in FIG. 1. The front doors 12 are hinged to a front structural pillar (i.e., the A-pillar 16), while the rear doors 14 are hinged to an intermediate structural pillar (i.e., the B-pillar 18), which is situated between the front and rear doors 12, 14. The latch assemblies 20 associated with the front doors 12 are arranged to latch with a front striker (not shown) fixed to the B-pillar 18. Likewise, the latch assemblies 22 associated with the rear doors 14 are arranged to latch with a rear striker 24 fixed to a rearward, vertically extending shut face 25 of the opening 26.

As a further advancement, power door or power closure member actuation systems have been developed. For passenger doors, like those described above, the power closure member actuation or power closure system can function to automatically swing the doors about their pivot axes between the open and closed positions, to assist the user as he or she moves the door, and/or to pop out or present the door to the user. Typically, power closure systems include a power-operated device such as, for example, an electric motor and a rotary-to-linear conversion device that are operable for converting the rotary output of the electric motor into translational movement of an extensible member. In many arrangements, the electric motor and the conversion device are mounted to the door and the distal end of the extensible member is fixedly secured to the vehicle body. One example of a power closure system for a passenger door is shown in commonly-owned International Publication No. WO2013/013313 to Schuering et al. which discloses use of a rotary-to-linear conversion device or power actuator having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions or maintaining the door in a specific position with a hold open function. Nevertheless, difficulties are typically encountered holding the doors in the specific position with the hold open function due to differences in tolerances of the doors.

In view of the above, there remains a need to develop alternative power closure systems which address and overcome limitations and drawbacks associated with known systems, as well as to provide increased convenience and enhanced operational capabilities.

### SUMMARY

This section provides a general summary of the present disclosure and is not a comprehensive disclosure of its full scope or all of its features, aspects and objectives.

It is an aspect of the present disclosure to provide a power closure system for a vehicle. The system includes a door and a power actuator for moving the door between closed and open positions. The power actuator is adapted to output a holding force to hold the door at a hold position between the closed position and the open position. In addition, the power actuator is configured to output the holding force such that a force applied to the door by a user to overcome the holding force is substantially the same to move the door in either one of an opening direction and a closing direction.

It is another aspect of the disclosure to provide another power closure system for a vehicle including a door and a power actuator for moving the door between closed and open positions. The power actuator is operated using a predetermined door system model. The operation of the power actuator using the predetermined door system model is adapted based on an actual monitored behavior of the door during a manual movement of the door by a user.

It is yet another aspect of the disclosure to provide an additional power closure system for a vehicle including a door and a power actuator for moving the door between closed and open positions. The power actuator is adapted to output a holding force to hold the door at a hold position between the closed position and the open position. Furthermore, the holding force of the power actuator is adapted over time based on an actual monitored behavior of the door moving out of the holding position.

Another aspect of the present disclosure relates to a method of operating a power closure system for a vehicle having a door. The method includes the step of moving the door between closed and open positions using a power actuator. The method also includes outputting a holding force to hold the door at a hold position between a closed position and an open position using the power actuator, the holding force selected such that a force applied to the door by a user to overcome the holding force is substantially the same to move the door in either one of an opening direction and a closing direction.

Yet another aspect of the present disclosure relates to a method of operating a power closure system for a vehicle having a door. The method includes the step of detecting no motion of the door at a steady state using at least one of a plurality of position sensors disposed on one of the doors and configured to detect a position of the one of the doors associated therewith. The method continues by monitoring an electrical current of the electric motor during the steady state. Next, detecting motion of the door. The method proceeds with the step of storing the electrical current of the electric motor at a position of the door at a moment the door is detected to move in the opening direction. The next step of the method is storing the electrical current of the electric motor at another position of the door at another moment the door is detected to move in the closing direction. The method continues with the step of using the electrical current of the electric motor at the position of the door at the moment the door is detected to move in the opening direction and the electrical current of the electric motor at the another position of the door at the another moment the door is detected to move in the closing direction, calculating a mid holding current at positions of the door between the electrical current of the electric motor at the position of the door at the moment the door is detected to move in the opening direction and the electrical current of the electric motor at the another position of the door at the another moment the door is detected to move in the closing direction. Next, adjusting the holding current to a balanced holding current equal to the mid holding current. The next step of the method is using the balanced holding current to control the electric motor of the power actuator to hold the door.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a motor vehicle equipped with separate latch assemblies for each door in accordance with the prior art;

FIG. 2 shows another motor vehicle equipped with separate latch assemblies and power actuators for each door that are operated by a passive entry feature used in conjunction with an electronic key fob, according to aspects of the disclosure;

FIG. 3 is a perspective inner side view of a closure member shown in FIG. 1, with various components removed for clarity purposes only, in relation to a portion of the vehicle body and which is equipped with the power closure member actuation system, according to aspects of the disclosure;

FIG. 4 illustrates the power closure member actuation system shown as part of vehicle system architectures according to aspects of the disclosure;

FIG. 5 is a plot of a target holding current (I_hold_target), maximum holding current (I_hold_max), a minimum holding current (I_hold_min), and an actual holding current (Actual) at a plurality of positions of the door according to aspects of the disclosure;

FIG. 6 illustrates the closed loop current feedback motor control system and the motor controller comprising the drive unit and the closed loop current feedback motor control system that may be included in the at least one controller according to aspects of the disclosure; and

FIGS. 7 and 8 illustrate steps of a method of operating a power closure system according to aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, at least one example embodiment of a power closure member actuation system and corresponding method of operation constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

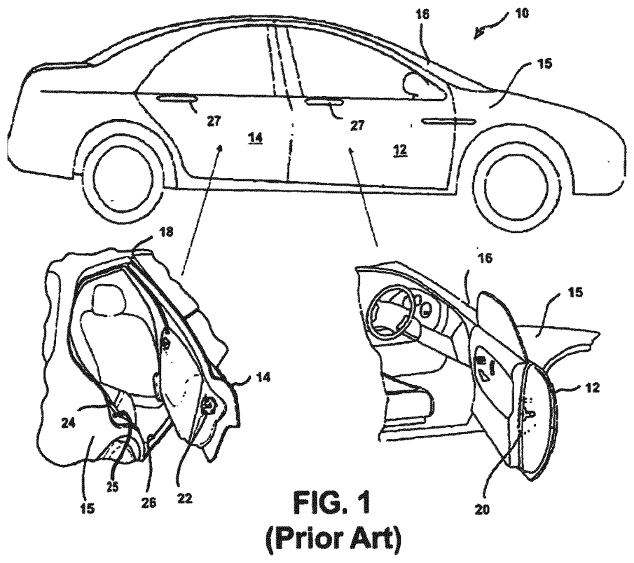

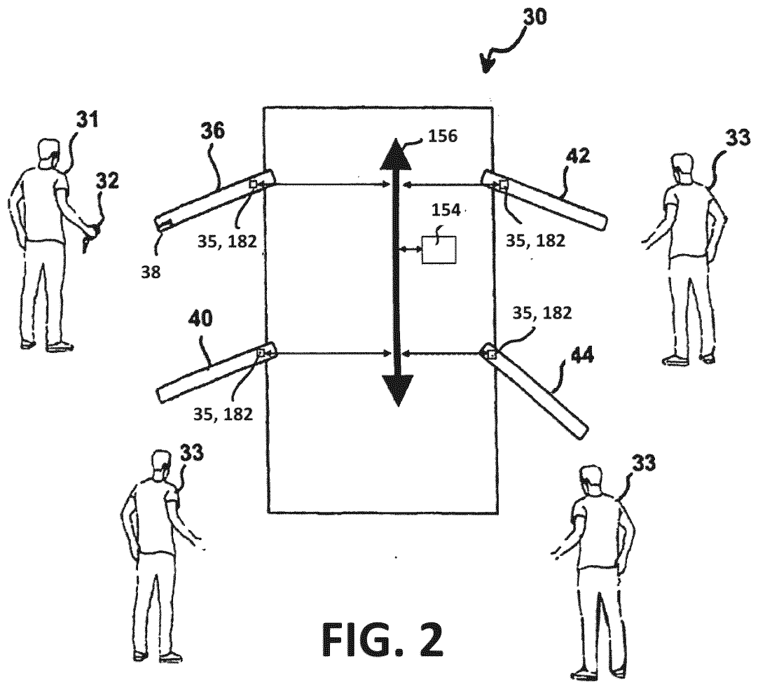

Referring to FIG. 2, for a vehicle 30 with a passive entry feature, a person 31 may approach the vehicle 30 and actuate (i.e. pull) an outside door handle 27 (FIG. 1) or electronically command unlatching and opening with an electronic key fob 32. For example, a single closure member opening command from the key fob 32 can be used for unlatching a driver's side front door 36 (i.e., the driver's door) and/or control a power actuator 35 configured to move the driver's side front door 36 between an open position and a closed position. Consequently, a latch assembly 38 associated with the driver's side front door 36 actuates the power release function to release a latch mechanism of the latch assembly 38 and unlatch for opening the driver's side front door 36 using the power actuator 35. A second or subsequent command from the key fob 32 can be used for unlatching the remaining doors for passengers 33 (e.g., driver's side rear door 40, passenger's side front door 42 opposite the driver's side front door 36, and passenger's side rear door 44 opposite the driver's side rear door 40) and controlling power actuators 35 configured to move the driver's side rear door 40, passenger's side front door 42, and passenger's side rear door 44 between open and closed positions, as shown. Accordingly, all of the doors 36, 40, 42, 44 may be unlocked and commanded open by the second closure member opening command from the key fob 32, even if the person 31 only wants to unlock the driver's side rear door 40. Similarly, the doors 36, 40, 42, 44 may also be automatically closed using the power actuators 35. However, the doors 36, 40, 42, 44 may move at different speeds and/or stop motion (e.g., at the open position or closed position) at different times.

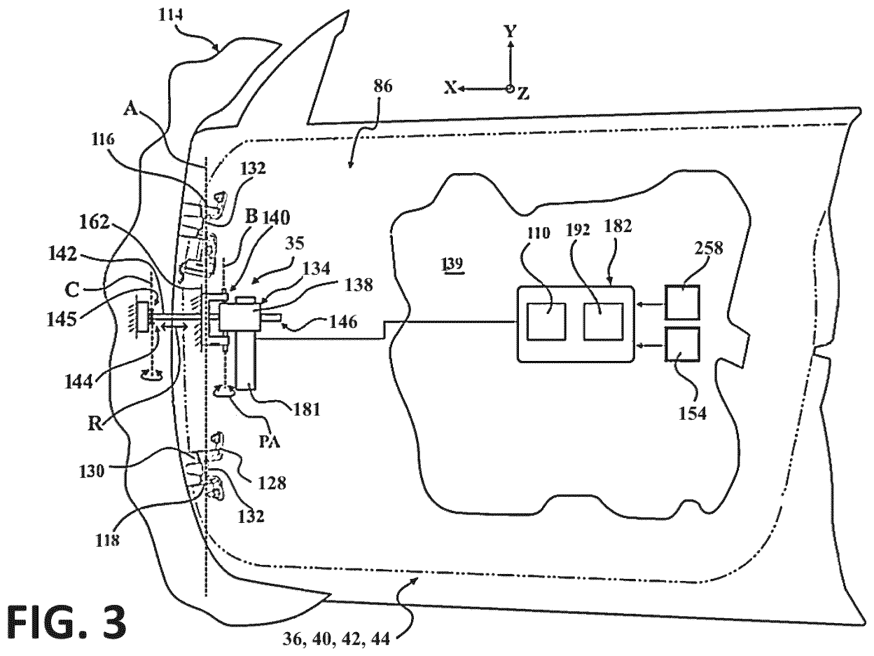

Power closure member actuation system 86 is generally shown in FIG. 3 and, as mentioned, is operable for controllably pivoting door 36, 40, 42, 44 relative to vehicle body 114 between an open position and a closed position. As shown in FIG. 3, lower hinge 118 of power closure member actuation system 86 includes a door hinge strap 128 connected to door 36, 40, 42, 44 and a body hinge strap 130 connected to vehicle body 114. Door hinge strap 128 and body hinge strap 130 of lower door hinge 118 are interconnected along a generally vertically-aligned pivot axis A via a hinge pin 132 to establish the pivotable interconnection between door hinge strap 128 and body hinge strap 130. However, any other mechanism or device can be used to establish the pivotable interconnection between door hinge strap 128 and body hinge strap 130 without departing from the scope of the subject disclosure.

Still referring to FIG. 3, power closure member actuation system 86 includes the power actuator 35 having a motor and geartrain assembly 134 that is rigidly connectable to door 36, 40, 42, 44. Illustratively, the power closure member actuation system 86 is pivotally connected to the shut face 162 of the door 36, 40, 42, 44. Motor and geartrain assembly 134 is configured to generate a rotational force about pivot axis A. In the preferred embodiment, motor and geartrain assembly 134 includes an electric motor 181 that is operatively coupled to a speed reducing/torque multiplying assembly 138, as a gearbox having one or more stages with a gear ratio allowing motor 181 and geartrain assembly 134 to generate a rotational force having a high torque output by way of a very low rotational speed of electric motor 181. However, any other arrangement of motor and geartrain assembly 134 can be used to establish the required rotational force without departing from the scope of the subject disclosure. Electrical motor 181 is controlled by the at least one controller 154, 182 in FIG. 3 which may include a microprocessor 110 and power electronics 192, such as H-bridge, FETS for example, controlled by the microprocessor 110. The at least one controller 154, 182 is electrically connected to command sources such as a door open or close switch (e.g., closure member switch 258), or to another controller, such as a Body Control Module 154, or an authentication controller such as PKE controller for example. According to an aspect, the at least one controller 154, 182 includes a plurality of door control units 182 each disposed in one of the plurality of doors 36, 40, 42, 44 and configured to control the speed of each of the plurality of doors 36, 40, 42, 44.

Motor and geartrain assembly 134 includes a mounting bracket 140 for establishing the connectable relationship with door 36, 40, 42, 44 and the power actuator 35. The connectable relationship of the power actuator 35 with the door 36, 40, 42, 44 via the mounting bracket 140 is illustrated as a pivotal connection to allow the power actuator 35 to pivot about a pivot axis B, for example with rotations indicated as PA in FIG. 3. Mounting bracket 140 is configured to be connectable to door 36, 40, 42, 44 between the upper door hinge 116 and lower hinge 118, and for example connectable to the shutface 162. Shutface 162 includes a port or aperture for allowing the drive shaft 142 to pass through the shutface 162, where such a port may be normally associated for allowing a door check link to pass therethough. As further shown in FIG. 3, this mounting of motor assembly 134 in manners as will be described herein disposes the power actuator 35 of power closure member actuation system 86 in close proximity to the pivot axis B. The mounting of motor and geartrain assembly 134 adjacent to the pivot axis B of door 36, 40, 42, 44 minimizes the effect that power closure member actuation system 86 may have on a mass moment of inertia (i.e., pivot axis A) of door 36, 40, 42, 44, thus improving or easing movement of door 36, 40, 42, 44 between its open and closed positions. Reducing the mass of the actuator and moving the mass of the actuator 22 closer to the pivot axis A reduces the mass of the door 36, 40, 42, 44 and shifts the center of mass closer to the pivot axis C allowing for the motor 181 power and/or size to be reduced. In addition, as also shown in FIG. 3, the mounting of motor and geartrain assembly 134 closer to pivot axis A of door 36, 40, 42, 44 allows power closure member actuation system 86 to be packaged in front of an A-pillar glass run channel and other internal door components and sheet metal panels associated with door 36, 40, 42, 44 and thus avoids any interference with a glass window function of door 36, 40, 42, 44. Put another way, power closure member actuation system 86 can be packaged in a portion of an internal door cavity 139 within door 36, 40, 42, 44 that is not being used, and therefore reduces or eliminates impingement on existing hardware/mechanisms within door 36, 40, 42, 44. Although power closure member actuation system 86 is illustrated as being mounted between the upper door hinge 116 and the lower hinge 118 of door 36, 40, 42, 44, power closure member actuation system 86 can, as an alternative, also be mounted elsewhere within door 36, 40, 42, 44 or even on vehicle body 114 without departing from the scope of the subject disclosure.

Power closure member actuation system 86 further includes the rotary drive mechanism that is rotatively driven by the power actuator 35. As shown in FIG. 3, the rotary drive mechanism includes the drive shaft 142 interconnected to an output member of gearbox 138 of motor and geartrain assembly 134 and which extends and retracts from both sides of the gearbox 138. In addition, as an optional configuration although not expressly shown, a clutch such as a mechanical or electrical clutch may be disposed between the rotary output of gearbox 138 and first end 144 of drive shaft 142. The clutch may engage and disengage using any suitable type of clutching mechanism such as, for example, a set of sprags, rollers, a wrap-spring, friction plates, or any other suitable mechanism. The clutch may be provided to permit door 36, 40, 42, 44 to be manually moved by the user between its open and closed positions relative to vehicle body 114. Such a clutch could, for example, also be located between the output of electric motor 181 and the input to gearbox 138. The location of this optional clutch may be dependent based on, among other things, whether or not gearbox 138 includes back-drivable gearing. In another possible configuration the power closure member actuation system 86 may not be provided with a clutch, which as a result reduces the mass of the power closure member actuation system 86 and of the door 36, 40, 42, 44. Possibly the gearbox 138 may include “back-drivable” gearing to allow a user to manually move the door 36, 40, 42, 44 whereby the gearing of the gearbox 138 will be induced to rotate. Possibly the gearbox 138 may alternatively include non-back-drivable preventing a user to manually move the door 36, 40, 42, 44 whereby the gearing of the gearbox 138 cannot be induced to rotate by movement of the door 36, 40, 42, 44, but rather only an activation of the motor 181 will cause the gearing of gearbox 138 to rotate to move the door 36, 40, 42, 44. A brake mechanism which prevents anyone of the rotation of the motor 181, the gearbox 138, or movement of the drive shaft 142 may also not be provided with the power closure member actuation system 86 to also further reduce mass of the power closure member actuation system 86 and the door 36, 40, 42, 44.

To accommodate angular motion due to swinging movement of door 36, 40, 42, 44 relative to vehicle body 114, the power closure member actuation system 86 further includes a pivotal connection 145 disposed between the vehicle body 114 and the first end 144 of drive shaft 142. Second end 146 of drive shaft 142 is configured to reciprocate into and out of cavity 139 as drive shaft 142 is driven by the gearbox 138 in response to actuation of motor 181. Illustratively connection 145 is a pin and socket type connection allowing rotation of the drive shaft 142 about an axis C, which extends parallel or substantially parallel to pivot axis A of the door 36, 40, 42, 44 and to the pivot axis B of the power actuator 35. Translation of drive shaft 142 via operation of motor and geartrain assembly 134 functions to push the door 36, 40, 42, 44 away from the vehicle body 114 when the drive shaft 142 is retracted from the cavity 139 and to pull the door 36, 40, 42, 44 towards the vehicle body 114 when the drive shaft 142 is translated into the cavity 139. As a result, power closure member actuation system 86 is able to effectuate movement of door 36, 40, 42, 44 between its open and closed positions by “directly” transferring a rotational force to the vehicle body 114 via linear translation of the driven drive shaft 142 in the illustrated example of FIG. 3. With motor and geartrain assembly 134 connected to door 36, 40, 42, 44 adjacent to the shut face 162, second end 146 of drive shaft 142 may reciprocate and swing within cavity 139 as driven shaft 142 reciprocates R within gearbox 138. Based on available space within door cavity 139, second end 146 of drive shaft 142 may avoid collision with internal components within cavity 139 as the power actuator 35 swings about axis B since for example the drive shaft 142 is retracted out of the cavity 139 as the door 36, 40, 42, 44 is opened.

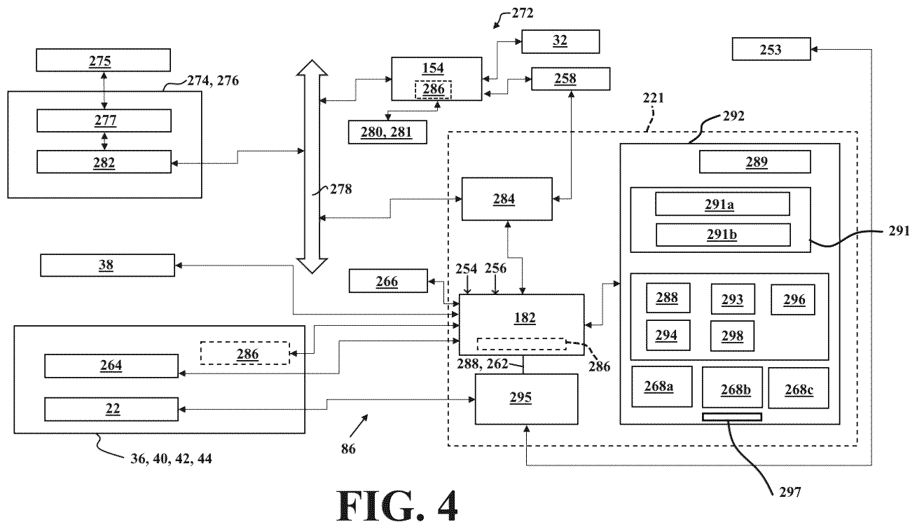

In FIG. 4, a door control system 221 of the power closure member actuation system 86 is shown as part of a vehicle system architecture 272 corresponding to operation in an automatic mode. The power closure member actuation system 86 includes a user interface 274, 276 that is configured to detect a user interface input from a user 275 (e.g., person 31 or passenger 33) via an interface 277 (e.g., touchscreen) to modify at least one stored motion control parameter associated with the movement of the closure member (e.g., door 36, 40, 42, 44). Thus, the at least one controller 154, 182 of the power closure member actuation system 86 or user modifiable system is configured to present the at least one stored motion control parameter on the user interface 274, 276.

The at least one controller 154, 182 is configured to receive an automatic mode initiation input 254 and enter the automatic mode to output a motion command 262 in response to receiving the automatic mode initiation input 254 or an input motion command 262. The automatic mode initiation input 254 can be a manual input on the closure member itself or an indirect input to the vehicle 10, 30 (e.g., closure member switch 258 on the door 36, 40, 42, 44, switch on a key fob 32, etc.). So, the automatic mode initiation input 254 may, for example, be a result of a user or operator 275 operating a switch (e.g., the closure member switch 258), making a gesture near the vehicle 10, 30, or possessing the key fob 32 near the vehicle 10, 30, for example. It should also be appreciated that other automatic mode initiation inputs 254 are contemplated, such as, but not limited to a proximity of the user 275 detected by a proximity sensor.

In addition, the power closure member actuation system 86 includes at least one closure member feedback sensor 264 for determining at least one of a position and a speed and an attitude of the closure member or door 36, 40, 42, 44. Thus, the at least one closure member feedback sensor 264 detects signals from either the power actuator 35 by counting revolutions of an electric motor of the power actuator 35, absolute position of an extensible member (not shown), or from the door 36, 40, 42, 44 (e.g., an absolute position sensor on a door check as an example) can provide position information to the at least one controller 154, 182. Feedback sensor 264 is in communication with the at least one controller 154, 182 and is illustrative of part of a feedback system or motion sensing system for detecting motion of the door 36, 40, 42, 44 directly or indirectly, such as by detecting changes in speed and position of the door 36, 40, 42, 44, or components coupled thereto. For example, the motion sensing system may be hardware based (e.g. a hall sensor unit an related circuitry) for detecting movement of a target on the closure member (e.g. on the hinge) or actuator 35 (e.g. on a motor shaft) as examples, and/or may also be software based (e.g. using code and logic for executing a ripple counting algorithm) executed by the at least one controller 154, 182 for example.

The body control module 154 is in communication with the at least one controller 154, 182 via a vehicle bus 278 (e.g., a Local Interconnect Network or LIN bus). The body control module 154 can also be in communication with the key fob 32 (e.g., wirelessly) and a closure member switch 258 configured to output a closure member trigger signal through the body control module 154. Alternatively, the closure member switch 258 could be connected directly to the at least one controller 154, 182 or otherwise communicated to the at least one controller 154, 182. The body control module 154 may also be in communication with an environmental sensor (e.g., temperature sensor 280). The at least one controller 154, 182 is also configured to modify the at least one stored motion control parameter in response to detecting the user interface input. A screen communications interface control unit 282 associated with the user interface 274, 276 can, for example, communicate with a closure communications interface control unit 84 associated with the at least one controller 154, 182 via the vehicle bus 278. In other words, the closure communication interface control unit 284 is coupled to the vehicle bus 278 and to the at least one controller 154, 182 to facilitate communication between the at least one controller 154, 182 and the vehicle bus 278. Thus, the user interface input can be communicated from the user interface 274, 276 to the at least one controller 154, 182.

A vehicle inclination sensor 286 (such as an accelerometer) is also coupled to the at least one controller 154, 182 for detecting an inclination of the vehicle 10, 30. The vehicle inclination sensor 286 outputs an inclination signal corresponding to the inclination of the vehicle 10, 30 and the at least one controller 154, 182 is further configured to receive the inclination signal and adjust the one of a force command 288 and the motion command 262 accordingly. While the vehicle inclination sensor 286 may be separate from the at least one controller 154, 182, it should be understood that the vehicle inclination sensor 286 may also be integrated in the at least one controller 154, 182 or in another control module, such as, but not limited to the body control module 154.

The at least one controller 154, 182 is further configured to perform at least one of an initial boundary condition check prior to the generation of the command signal (e.g., the force command 288 or the motion command 262) and an in-process boundary check during the generation of the command signal. Such boundary checks prevent movement of the closure member and operation of the power actuator 35 outside a plurality of predetermined operating limits or boundary conditions 291 and will be discussed in more detail below.

The power closure member actuation system 86 additionally includes at least one non-contact obstacle detection sensor 266 which may form part of a non-contact obstacle detection system coupled, such as electrically coupled, to the at least one controller 154, 182. The at least one controller 154, 182 is configured to determine whether an obstacle is detected using the at least one non-contact obstacle detection sensor 266 and may, for example, cease movement of the doors 36, 40, 42, 44 in response to determining that the obstacle is detected.

The at least one controller 154, 182 can also be coupled to the latch assembly 38. In addition, the at least one controller 154, 182 is coupled to a memory device 292 having at least one memory location for storing at least one stored motion control parameter associated with controlling the movement of the closure member (e.g., one of the plurality of doors 36, 40, 42, 44). The memory device 292 can also store one or more closure member motion profiles 268 (e.g., movement profile A 268 a, movement profile B, 268 b, movement profile C 268 c) and boundary conditions 291 (e.g., the plurality of predetermined operating limits such as minimum limits 291 a, and maximum limits 291 b). The memory device 292 also stores original equipment manufacturer (OEM) modifiable door motion parameters 289 (e.g., door check profiles and pop-out profiles).

The at least one controller 154, 182 is configured to generate the motion command 262 using the at least one stored motion control parameter to control an actuator output force acting on the closure member to move the closure member. A pulse width modulation unit 295 is coupled to the at least one controller 154, 182 and is configured to receive a pulse width control signal and output an actuator command signal corresponding to the pulse width control signal. The pulse width modulation unit 295 is also connected to a vehicle battery 253.

The body control module 154 may also be in communication with at least one environmental sensor 280, 281 for sensing at least one environmental condition 259. Specifically, the at least one environmental sensor 280, 281 can be at least one of a temperature sensor 280 or a rain sensor 281. While the temperature sensor 280 and rain sensor 281 may be connected to the body control module 154, they may alternatively be integrated in the body control module 154 and/or integrated in another unit such as, but not limited to the at least one controller 154, 182. In addition, other environmental sensors 280, 281 are contemplated.

Again, the vehicle inclination sensor 286 (such as an accelerometer or inclinometer) is also coupled to the at least one controller 154, 182 for detecting the inclination of the vehicle 10, 30. The vehicle inclination sensor 286 outputs an inclination signal corresponding to the inclination of the vehicle 10, 30 and the at least one controller 154, 182 is further configured to receive the inclination signal and adjust the one of the force command 288 and the motion command 262 accordingly. Accordingly may be for example adjusting the motion command 262 such that one of the plurality of doors 36, 40, 42, 44 moves at the same speed and motion profile as compared to the one of the plurality of doors 36, 40, 42, 44 being moved by a motion command as if on a level terrain. As a result, the power actuator 35 may move the one of the plurality of doors 36, 40, 42, 44 such that the motion profile (e.g. speed versus door position) when on an incline is the same as or is tracking to the motion profile as if the vehicle was not on an incline. In other words the user detects no visual difference in the door motion appearance of speed versus position as when the vehicle 10, 30 is on an incline or not. Or for example accordingly may be adjusting the force command 88 such that one of the plurality of doors 36, 40, 42, 44 is moved applying the similar resistance force detected by a user as compared to the door being moved by a force command as if on level terrain. As a result, the power actuator 35 may move the door such that the force required to move the one of the plurality of doors 36, 40, 42, 44 by a user when on an incline is the same as the force required by a user to move the door as if the vehicle was not on an incline. In other words, the user experiences the same reactionary resistive force of the door 36, 40, 42, 44 acting against the input force of the user 275 when the vehicle 10, 30 is on an incline or not.

The pulse width modulation unit 295 is also coupled to the at least one controller 154, 182 and is configured to receive a pulse width control signal and output an actuator command signal corresponding to the pulse width control signal. The at least one controller 154, 182 is coupled to the memory device 292 for storing a plurality of automatic closure member motion parameters 268, 293, 294 for the automatic mode and a plurality of powered closure member motion parameters for the powered assist mode and used by the at least one controller 154, 182 for controlling the movement of the closure member (e.g., one of the plurality of doors 36, 40, 42, 44). Specifically, the plurality of automatic closure member motion parameters 268, 293, 294 includes at least one closure member motion profile 268 (e.g., plurality of closure member velocity and acceleration profiles), a plurality of closure member stop positions 293, and a closure member check sensitivity 294. The plurality of powered closure member motion parameters includes at least one of a plurality of fixed closure member model parameters and a force command generator algorithm and a closure member model and a plurality of closure member component profiles. In addition, the memory device 292 stores a date and mileage and cycle count. The memory device 292 may also store boundary conditions (e.g., plurality of predetermined operating limits) used for a boundary check to prevent movement of the closure member and operation of the power actuator 35 outside a plurality of predetermined operating limits or boundary conditions.

Consequently, the at least one controller 154, 182 is configured to receive one of the motion input 256 associated with the powered assist mode and the automatic mode initiation input 254 associated with the automatic mode. The at least one controller 154, 182 is then configured to send the power actuator 35 one of a motion command 262 based on the plurality of automatic closure member motion parameters 268, 293, 294 in the automatic mode and the force command 88 based on the plurality of powered closure member motion parameters in the powered assist mode to vary the actuator output force acting on the one of the plurality of doors 36, 40, 42, 44 to move the closure member or one of the plurality of doors 36, 40, 42, 44. The at least one controller 154, 182 additionally monitors and analyzes historical operation of the power closure member actuation system 86 and adjusts the plurality of automatic closure member motion parameters 268, 293, 294 and the plurality of powered closure member motion parameters accordingly.

As discussed above, the power closure member actuation system 86 can include the environmental sensor 280, 281 in communication with the at least one controller 154, 182 and configured to sense at least one environmental condition of the vehicle 10, 30. Thus, the historical operation monitored and analyzed by the at least one controller 154, 182 includes the at least one environmental condition of the vehicle 10, 30. So, the at least one controller 154, 182 is further configured to adjust the plurality of automatic closure member motion parameters 268, 293, 294 and the plurality of powered closure member motion parameters based on the at least one environmental condition of the vehicle 10, 30.

Still referring to FIG. 4, the power closure system 86 can include the door 36, 40, 42, 44 and the power actuator 35 for moving the door 36, 40, 42, 44 between closed and open positions. In addition, the power actuator 35 may be adapted to output a holding force to hold the door 36, 40, 42, 44 at a hold position between the closed position and the open position. A holding current is typically applied to the electric motor 181, which is the current required by the power actuator 35 to hold the door 36, 40, 42, 44 in the holding or steady position. This current generates a force by power actuator 35 to compensate all the forces acting on the door system 86. However, as each door 36, 40, 42, 44 may have different tolerances compared to a generic system model, while the door 36, 40, 42, 44 may still be held, a given holding current applied to the electric motor 181 may cause the electric motor 181 to exert more or less force in the direction of door opening or closing. This means that the force to move the door 36, 40, 42, 44 by the user 275 out of a hold open state may be sensed as being different depending on the direction of door motion, and may be different for each particular door 36, 40, 42, 44. Thus, the power closure system 86 described herein provides for a manner of adapting this hold open current so the force sensed by the user 275 moving the door 36, 40, 42, 44 out of the hold position is the same in either direction. Accordingly, the power actuator 35 is configured to output the holding force such that a force applied to the door 36, 40, 42, 44 by the user 275 to overcome the holding force is substantially the same to move the door 36, 40, 42, 44 in either one of an opening direction and a closing direction. According to another aspect, the operation of the power actuator 35 using the predetermined door system model 297 is adapted based on an actual monitored behavior of the door 36, 40, 42, 44 during a manual movement of the door 36, 40, 42, 44 by a user 275. According to a further aspect, the holding force of the power actuator 35 is adapted over time based on an actual monitored behavior of the door 36, 40, 42, 44 moving out of the holding position.

Again, the power closure system 86 can also include at least one controller 154, 182 coupled to the power actuator 35. The memory device 292 of the at least one controller 154, 182 stores the predetermined door system model 297. The at least one controller 154, 182 is configured to calculate a holding current to be applied to the power actuator 35 to maintain the door 36, 40, 42, 44 in the hold positon using the predetermined door system model 297. The at least one controller 154, 182 is also configured to adjusting the holding current to a balanced holding current to provide the holding force such that the force applied to the door 36, 40, 42, 44 by the user 275 to overcome the holding force is substantially the same to move the door 36, 40, 42, 44 in either one of the opening direction and the closing direction. So, an algorithm of the at least one controller 154, 182 used to control the power actuator 35 (i.e., PDU haptic algorithm) is based on modelling of the power door system 86. Specifically, parametrization is defined for the system 86 at a nominal condition. System tolerances could affect the behavior, causing different performance on different doors 36, 40, 42, 44. Tolerances could be related to the mechanical components of the power closure system 86, the at least one controller 154, 182, and/or the power actuator 35.

As discussed, the power closure system 86 further includes a plurality of position sensors 48 each disposed on one of the plurality of doors 36, 40, 42, 44 and coupled to the at least one controller 154, 182. Thus, according to aspects of the disclosure, the at least one controller 154, 182 is configured to detect no motion of the one of the plurality of doors 36, 40, 42, 44 at a steady state using at least one of the plurality of position sensors 48. In addition, the at least one controller 154, 182 is configured to monitor an electrical current of the electric motor 181 during the steady state. The at least one controller 154, 182 is further configured to detect motion of the one of the plurality of doors 36, 40, 42, 44. The at least one controller 154, 182 stores the electrical current of the electric motor 181 at a position of the one of the plurality of doors 36, 40, 42, 44 at a moment the door 36, 40, 42, 44 is detected to move in the opening direction, I_hold_max (opening). The at least one controller 154, 182 is also configured to store the electrical current of the electric motor 181 at another position of the one of the plurality of doors 36, 40, 42, 44 at another moment the one of the plurality of doors 36, 40, 42, 44 is detected to move in the closing direction I_hold_min (closing). The at least one controller 154, 182 is additionally configured to using the electrical current of the electric motor 181 at the position of the one of the plurality of doors 36, 40, 42, 44 at the moment the one of the plurality of doors 36, 40, 42, 44 is detected to move in the opening direction and the electrical current of the electric motor 181 at the another position of the one of the plurality of doors 36, 40, 42, 44 at the another moment the door 36, 40, 42, 44 is detected to move in the closing direction, calculate a mid holding current at positions of the one of the plurality of doors 36, 40, 42, 44 between the electrical current of the electric motor 181 at the position of the door 36, 40, 42, 44 at the moment the one of the plurality of doors 36, 40, 42, 44 is detected to move in the opening direction and the electrical current of the electric motor 181 at the another position of the one of the plurality of doors 36, 40, 42, 44 at the another moment the one of the plurality of doors 36, 40, 42, 44 is detected to move in the closing direction. Furthermore, the at least one controller 154, 182 is configured to adjust the holding current to a balanced holding current or target holding current (I_hold_target) equal to the mid holding current. The at least one controller 154, 182 is also configured to use the balanced holding current to control the electric motor 181 of the power actuator 35 to hold the one of the plurality of doors 36, 40, 42, 44.

In addition, a minimum holding current (I_hold_min) and maximum holding current (I_hold_max) are stored in the memory device 292 and indicated by numeral 296. A parameterization set of the door 36, 40, 42, 44 and the predetermined door system model 297 are also stored in the memory device 292. A nominal target current I_nominal, discussed in more detail below, is calculated by the parameterization set, based on the system model and is indicated by numeral 298.

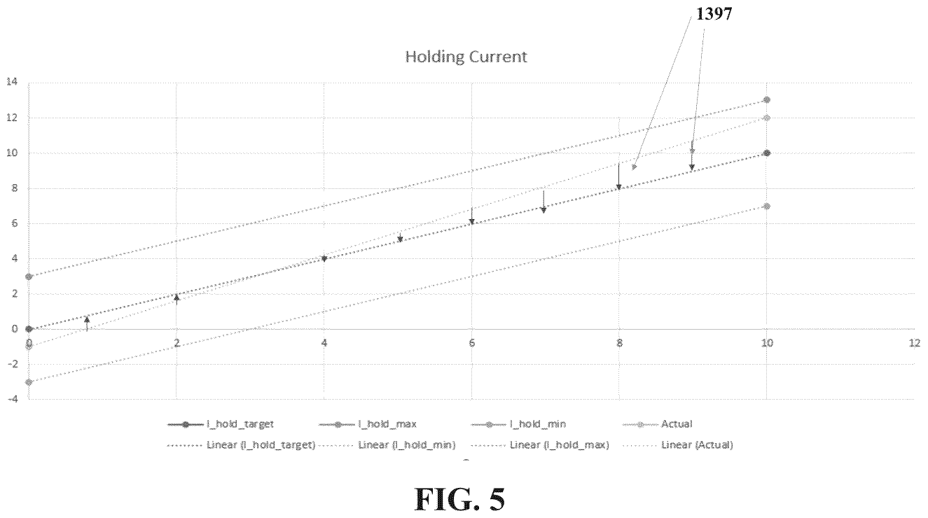

FIG. 5 is a plot of a target holding current (I_hold_target), maximum holding current (I_hold_max), a minimum holding current (I_hold_min), and an actual holding current (Actual) or I_nominal at a plurality of positions of the door 36, 40, 42, 44. To simplify the explanation, the various holding currents are represented as straight lines. The target holding current is based on the door model that is determined, but due to the different actual door tolerances between doors 36, 40, 42, 44, the target holding current may not provide consistent behavior between doors 36, 40, 42, 44, and so the objective is to adjust this holding current to a balanced holding current for each particular door 36, 40, 42, 44. The actual holding current may not exactly be the average between the min and max, so there are some positions in which it is next to the max and some in which it is next to the min. For example, at position 8, the actual holding current is higher than the target holding current, next to I_hold_max. Thus, the force required for manual opening is less than force required for manual closing. As another example, at position 2, the actual holding current is lower than the target holding current, next to I_hold_min. So, the force required for manual opening is higher than force required for manual closing. At position 3, the actual holding current is the same as the target holding current, so, same manual effort is needed for opening and closing.

In more detail, at position 8, to obtain a balanced holding current, the target holding current is adjusted downwards from the actual holding current line to the target holding current. While at position 8, the actual holding current would be enough to hold the door 36, 40, 42, 44 without moving it, the higher holding current closer to the maximum holding current means that a large current jump is needed to move the door closed (towards the minimum holding current) than would be to move the door to the maximum holding current. The user 275 would feel the door 36, 40, 42, 44 operating differently depending on which direction the door 36, 40, 42, 44 is moved. Thus the current is selected so that the holding force is balanced between the upper and lower holding thresholds (arrows in blue have the same magnitude). This adjustment to the holding current is applicable to the powered assist mode, and not the automatic mode, as automatic movement is not actually affected by this improvement; as it is based on speed and current control algorithm, the target current is to achieve the target speed. All forces are compensated automatically to achieve the target speed. So, according to an aspect, the at least one controller 154, 182 is configured to adjust the holding current in a powered assist mode and not in an automatic mode.

Still referring to FIG. 5, for example, the holding current is not a unique value, but can vary within a range between I_hold_min and I_hold_max. Current lower than I_hold_min causes the door to move (closing direction), current higher than I_hold_max causes the door to move (opening direction), and the Ideal/Target holding current should be the average curve of I_hold_max and I_hold_min. Starting an automatic opening from a steady state, the current value at the time position changes could be an evaluation of I_hold_max. Starting an automatic closing from a steady state, the current value at the time position changes could be an evaluation of I_hold_min. Thus, FIG. 5 illustrates that there is a zone (between upper and lower lines where the holding current would not cause the door 36, 40, 42, 44 to move. The holding current required is calculated using the model 297 and parameters of the door 36, 40, 42, 44. However, calculated holding current is adjusted to a balanced holding current such that the user 275 has to overcome the same holding force when they move the door 36, 40, 42, 44 in the opening or closing direction. For a given position (indicated as numeral 1397, the nominal holding force is adjusted to a mid point in the holding current range.

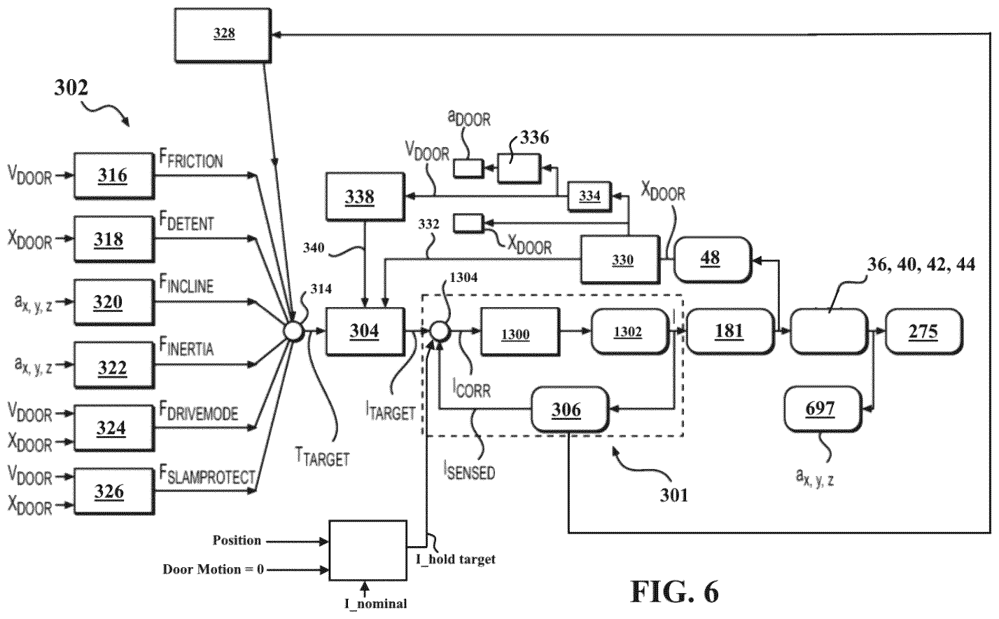

So, for the algorithm, one or more additional components shall be added to the haptic control or powered assist mode to measure the steady condition (no position change for a timeout), check for automatic movement requests, measure the current on power actuator 35 at the time position changes from steady condition, store these I_hold_max (opening) and I_hold_min (closing) values in a look-up table addressed by position, and calculate and store the average value at this position (I_target). The balanced holding current requested by drive unit 304 (FIG. 6) (I_adjusted) shall be adjusted with a correction factor that is the difference between the target holding current I_target and I_nominal (I_nominal is the nominal target current calculated in nominal condition, by means the one calculated by a current haptic algorithm). A correction current I_correction=I_target-I_nominal. The balanced holding current I_adjusted=I_nominal+I_correction Referring back to FIG. 5, the algorithm basically translates the actual holding current (Actual) to the target holding current (I_hold_target).

FIG. 6 illustrates the closed loop current feedback motor control system 301 and the motor controller 308 comprising the drive unit 304 and the closed loop current feedback motor control system 301 that may be included in the at least one controller 154, 182. Separation of the haptic control algorithm 302 from the motor controller 308 and the closed loop current feedback motor control system 301 provides for separation of control component between components which are dynamic, for example which require more frequent updates, maintenance, tuning, from those components which are static, for example those which do not require updates, or maintenance. For example, the haptic control algorithm 302 can be updated regularly with new functions, modules, and control features depending on the vehicle application, or depending on subsequent tuning of the system, or with additional improvements in the algorithm, and following installation of the system into the vehicle. For example, the haptic control algorithm 302 maybe updateable through the update functions of the Body Control Module 154. Closed loop current control system 301 may have associated units or modules represented in computer-executable instructions stored in a memory system having previously written memory that cannot be subsequently overwritten (e.g. such memory may be write protected, encrypted or encoded, or not accessible to an Original Equipment Manufacturer), while the haptic controller 302 may have associated units or modules represented in computer-executable instructions stored in the memory system having previously written memory that can be subsequently overwritten, for example by Original Equipment Manufacturer through a dedicated interface port, or through the software interface ports of the Body Control Module. Similarly, drive unit 304 may have associated units or modules represented in computer-executable instructions stored in a memory system having previously written memory that cannot or can be subsequently overwritten. In one possible embodiment, only the memory associated with the haptic control algorithm 302 may be overwritten allowing a customization of the haptic control algorithm 302 after installation to the particular vehicle the system is being installed therewith, while the memory associated with the closed loop current control system 301 and/or the drive unit 304 cannot be overwritten since the control of the power actuator 35 using the closed loop current control system 301 and the drive unit 304 may be independent from the actual installation environment of the power actuator 35 and tuned prior to installation of the system into the vehicle 10, 30. As a result the haptic control algorithm 302 may be provided as part of a centralized vehicle controller, such as the BCM 154, which is configured for ease of upgradability, such as via flashing or uploading as part of a regular system update, or as part of a dedicated update of the haptic control algorithm 302. So, the haptic control algorithm 302 can be provided as part of the centralized vehicle controller (e.g., BCM 154) not in the door 36, 40, 42, 44, while the closed loop current control system 301 can be provided within the door 36, 40, 42, 44. Furthermore, the haptic control algorithm 302 may involve computationally intense computations requiring access to a powerful processor, and as a result the haptic control algorithm 302 may be distributed into the distinct memory of separate main vehicle controller comprising such a powerful processor also used for controlling other system e.g. such as a ADAS system. Whereas low level feedback motor control system 301 and motor controller 308 may be static and not require regular or any updates, and may be provided in less accessibly parts of the vehicle 10, 30. For example, if the motor controller 308 is provided in a power side door actuator unit 622, an updating communication port may be removed as compared to if the haptic control algorithm 302 is also provided with the power side door unit 622. In addition, the closed loop current control system 301 may comprise a memory unit that cannot be overwritten or updated, while the haptic control algorithm 302 comprises a memory that can be overwritten.

Continuing to refer to FIG. 6, the accelerometer 697 provides an acceleration signal a_{x,y,z} to at least one of the closed loop current control system 301 and the haptic control algorithm 302. The haptic control algorithm 302 includes a summation of forces of a plurality from a plurality of force calculations 316, 318, 320, 322, 324, 326, 328 by a summer 314 that outputs the target torque T_{target} to the drive unit 304. The plurality of force calculations include a friction force calculation 316 that receives a velocity of the door 36, 40, 42, 44 V_{door} input and outputs a friction force F_{friction}, a detent force calculation 318 that receives a position of the door 36, 40, 42, 44 X_{door} input and outputs a detent force F_{detent}, an incline force calculation 320 that receives the acceleration signal a_{x,y,z} input and outputs an incline force F_{incline}, an inertia force calculation 322 that receives the acceleration signal a_{x,y,z} input and outputs an inertia force Fᵢₙₑᵣₜᵢₐ, a drive mode force calculation 324 that receives the position of the door 36, 40, 42, 44 x_{door} and the velocity of the door 36, 40, 42, 44 V_{door} input and outputs a drive mode force F_{drivemode}, a slam protect force calculation 326 that receives the position of the door 36, 40, 42, 44 x_{door} and the velocity of the door 36, 40, 42, 44 V_{door} input and outputs a slam protect force F_{slamprotect}, and a user input torque force calculation 328 that receives the sensed current I_{sensed} input from the current sensor 306 and outputs a user input torque force Fᵤₛₑᵣᵢₙₚᵤₜ. So, according to an aspect, the same accelerometer 697 can be used to determine vehicle inclination and can also be used for door inertia.

Door position sensors 48 are coupled to a kinematic block 330 configured to receive the position of the door 36, 40, 42, 44 X_{door} and output a first force input 332 to the drive unit 304. Kinematic block 330, as an example of a compensating block or unit for internally generated factors to the power actuator 35, may be adapted to provide a signal resulting from a calculated kinematic compensation force value, which may be a torque value for example, to the drive unit 304 to vary the target current I_{target} to compensate for any variations in the actuator characteristics tending to cause a deviation of the actual motor torque output T from the target torque T_{target}. One example kinematic of the power actuator 35 that the kinematic block 330 is adapted to compensate for is the moment arm of the power actuator 35. Kinematic unit 330 may be configured for calculating a kinematic compensation force to be supplied to the drive unit 304. Signals from the door position sensors 48 are transmitted to the haptic control algorithm 302 and the drive unit 304. Without such door position information, the drive unit 304 may not be able to properly track movement of the door 36, 40, 42, 44, and the compensation algorithms may not be certain of the data being received. The kinematic block 330 is also coupled to a first differentiator 334 configured to mathematically differentiate the position of the door 36, 40, 42, 44 X_{door} and output the the velocity of the door 36, 40, 42, 44 V_{door}. The first differentiator 334 is then coupled to a second differentiator 336 configured to mathematically differentiate the velocity of the door 36, 40, 42, 44 V_{door} and output an acceleration of the door 36, 40, 42, 44 a_{door}. The velocity of the door 36, 40, 42, 44 V_{door} is received by a backdrive block 338 that is configured to receive the velocity of the door 36, 40, 42, 44 V_{door} and output a second force input 340 to the drive unit 304. The backdrive block 338, as an example of a compensating block or unit for internally generated factors of the power actuator 35, may be adapted to provide a signal resulting from a calculated drive/backdrive compensation force value, which may be a torque value for example, to be supplied to the drive unit 304 to vary the target current I_{target} to compensate for any variations in the actuator characteristics tending to shift the motor torque output T from the target torque T_{target}. Backdrive block 338 may be implemented as a system model stored in a memory. The system model of backdrive block 338 may be based on a precalibration of the geartrain assembly stored in a memory. One example characteristic of the power actuator 35 that the kinematic block 330 is adapted to compensate for is the backdrive characteristics of the power actuator 35 due to gearing for example e.g. of the reduction geartrain. Kinematic block 330 may be implemented as a system model stored in memory. Kinematic block 330 may include lookup tables for outputting a force adjustment value based on the position of the door for example. The drive unit 304 receives the first and second force inputs 332, 340 and outputs the target current I_{target}. So, the drive unit 304 receives the torque F_{haptic} input or target torque T_{target} from the haptic control algorithm 302 and is a separate function that collects parameters, processes all of the variable and decides what to do to the motor 181.

The motor controller 308 is shown illustratively as adapted to compensate for internal influences capable of influencing the motion of the door 36, 40, 42, 44. Internal influences may include effects on door motion attributed or originating from or associated with irregularities of the powered actuator 35, which may include but not be limited to gear train factors such as gearbox (backlash reactions, lag, slop, slack, differences in operation between a back driven direction and a forward driven direction of the powered actuator 35, loss of efficiency, as but non-limiting examples), internal friction factors due to gearing or bushing types, moment variations due to connection/mounting points of the powered actuator 35 with the vehicle body and/or vehicle door, use of a flex coupling or other types of shock absorbing couples, use of a clutch or brake mechanism, a spindle/nut interface, or other associated characteristics. Such effects may result in door motion differences in expected door motion compared to actual door motion due to the powered actuator 35 not outputting the predetermined target force value, for example received from the output of the haptic control algorithm 302 e.g. powered actuator 35 does not cause a T_{target} to be applied to the door as a motor torque output T. Motor controller 308 is therefore configured to generate a control signal provided to the motor 181 that is varied or adjusted to counteract any internal influences or effects attributed to the power side door actuator 35. Therefore a system 300 for controlling the motion of a door 36, 40, 42, 44 is provided that illustratively includes a power side door actuator 35 comprising a motor 181 for generating an output force for moving the door 36, 40, 42, 44, and a motor controller for controlling the motor 181 at a target output force (T_{target}), wherein the motor controller is adapted to compensate for effects associated with the power side door actuator 35 that vary the force output (T) of the motor 181 compared to the target output force (T_{target}) such that the actual force applied to the door 36, 40, 42, 44 is the same as the calculated target output force (T_{target}). For example, if the motor 181 is intended to be controlled using a T_{target} equal to 10 newton-meters such that 10 newton-meters in force is expected to be applied to the door 36, 40, 42, 44, and the power side door actuator 35 has an effect tending to cause a difference between the force command value and the actual force output, for example the actual force imparted by extensible member 142 acting on the vehicle body 114 to move the door 36, 40, 42, 44 as described herein above is actually 9.5 newton-meters, that is 0.5 newton-meters than the calculated target force. Such difference may be due to for example internal friction causing the actual motor output T to be reduced by 0.5 newton-meters, the at least one controller 154, 182 is adapted to adjust the T_{target} from 10 newton-meters to 10.5 newton-meters, such that the output motor force applied to the door 36, 40, 42, 44 is equal to the expected output force acting on the door 36, 40, 42, 44 of 10 newton-meters (10.5 newton-meters-0.5 newton-meters). As another example due to power side door actuator 35 operating inefficiencies/irregularities due to back drive operation and forward drive operational differences (for example due to the geartrain), requiring the motor 181 to be operated differently when controlled in either the backdrive direction or the forward drive direction as determined by block 338, the at least one controller 154, 182, for example drive unit 304 is adapted to adjust the T_{target} to overcome the loss of efficiency when the power side door actuator 35 is operated in the back drive direction, such that actual motor output T matches T_{target}. Providing a compensation for the internal irregularities of the power side door actuator 35 allows the system to properly respond to the user's touch on the door 36, 40, 42, 44 by providing an appropriate haptic force sensation/response to the user 275. Since the human touch has a high tactile sensitivity, compensating for power side door actuator 35 irregularities, even if minor so as not to be visually noticeable provides an improved experience to the user moving the door 36, 40, 42, 44 through constant haptic interaction e.g. touch. Internal irregularities of the power side door actuator 35 cause the actual output of the power side door actuator 35 to move the door with a target force to deviate from a desired or intended output of the power side door actuator 35 as determined by the control system of the power side door actuator 35. Such discrepancies between the intended force acting on the door to move the door and the actual force acting on the door may be due to single or multiple cumulative irregularities of the power side door actuator 35 which may include irregularities caused by internal friction or inertia, irregularities caused by geartrain characteristics such as differences in backdrive versus forward drive responses of a geartrain, slop or slack in the geartrain, irregularities caused by moment arms of power side door actuator 35 due to mounting configurations which causes a change in force output acting on the door depending on door position for example, irregularities in usage or wear of the actuator 35 over time caused by degradation of internal components, irregularities in response due to the actuator temperature, as but non-limiting examples. Such irregularities may cause delays or lag in response times in response to the application of a force on the door for moving the door triggering the haptic motor control, as well as a difference in targeted force actually acting on the door by the power side door actuator 35, and differences in door motion depending on the direction of motion of the door e.g. towards the closed position or the open position, for example. Through mitigation or reduction or elimination of such irregularities, the quality of door interaction by a user may be enhanced. As the user may be in constant touch interaction with the door during its door operation, by compensating for such irregularities of power side door actuator 35, the user experience through the sense of touch may be improved by reducing noticeable sensations due to force assist during operation of the door, including perceived jerkiness or shuttering of the door during initial activation of the power side door actuator 35 or change in directions of the door, differences in force assist magnitude during opening versus closing direction, differences in force assist magnitude during a single opening direction, differences in force assist magnitude during transition between opening and closing direction, differences in force assist magnitude depending on environmental operating conditions of the power side door actuator 35, a degradation in force assist depending on the age of the power side door actuator 35, all as but non-limiting examples. Irregularities may be inherent in the components and configurations of the power side door actuator 35, which may be static and not change over time, or may be dynamic and change over time. Further irregularities may vary based on external factors affecting the actuator, such as environmental temperature, and door position, as examples.

The closed loop current control system 301 includes a motor block 1300 connected to an H-bridge block 1302. A subtractor 1304 subtracts the sensed current I_{sensed} from the current sensor 306 from the target current I_{target} to output a corrected current I_{corr} to the motor block 1300. The motor block 1300 and H-bridge block 1302 are configured to convert the corrected current I_{corr} to the drive current I which is sensed by the current sensor 306. Motor block 1300 illustratively implements a PID control function having three control terms of proportional, integral and derivative influence, for example.

So, the target holding current (I_hold_target) is determined based on the position of the door 36, 40, 42, 44, no motion of the door 36, 40, 42, 44 detected, and the nominal holding current I_nominal. The balanced or compensated holding current is inputted directly into the subtractor 1304 as a current value.

According to an aspect, a routine for a first look-up table initialization at may be executed as an end of line test when the vehicle 10, 30 reaches the end of the assembly line. According to another aspect, the measurements for different inclinations and temperatures may be expanded.

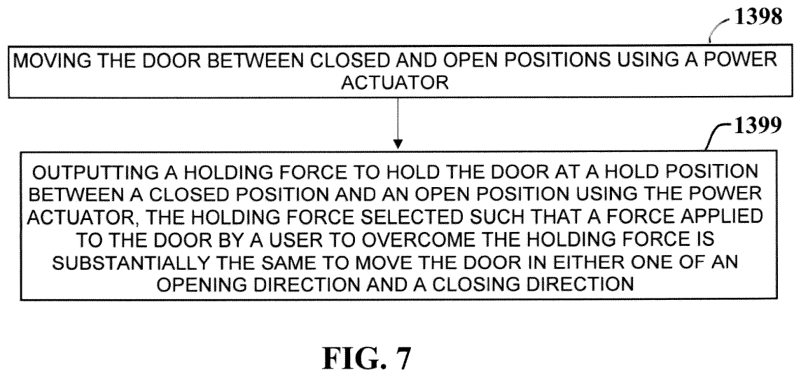

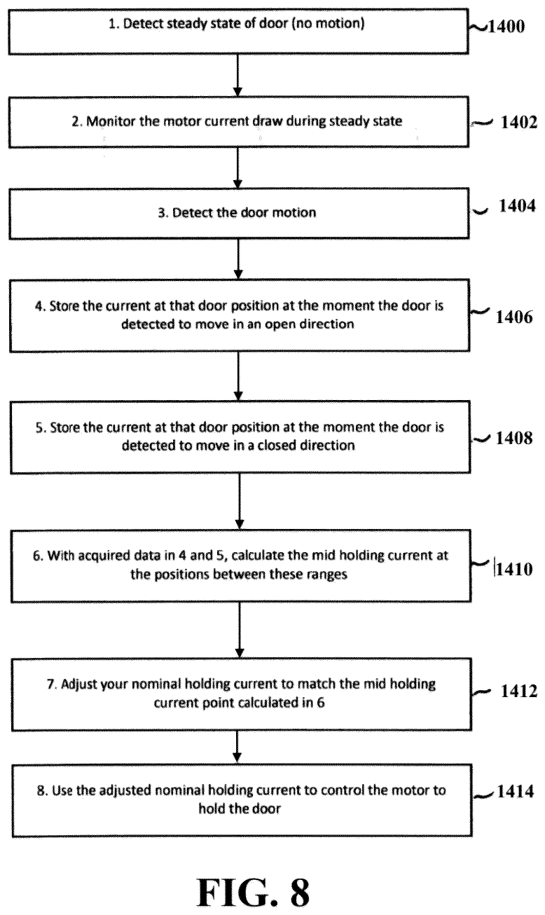

FIGS. 7 and 8 illustrate steps of a method of operating a power closure system 86. Referring initially to FIG. 7, the method includes the step of 1398 moving the door 36, 40, 42, 44 between closed and open positions using a power actuator 35. The method also includes the step of 1399 outputting a holding force to hold the door 36, 40, 42, 44 at a hold position between a closed position and an open position using the power actuator 35. The holding force is selected such that a force applied to the door 36, 40, 42, 44 by a user 275 to overcome the holding force is substantially the same to move the door 36, 40, 42, 44 in either one of an opening direction and a closing direction.

According to an aspect, the method may also include the step of storing a predetermined door system model 297 in a memory device 292 of at least one controller 154, 182 coupled to the power actuator. The method can continue by calculating a holding current to be applied to the power actuator 35 to maintain the door 36, 40, 42, 44 in the hold positon using the predetermined door system model 297. The method may further include the step of adjusting the holding current to a balanced holding current to provide the holding force such that the force applied to the door 36, 40, 42, 44 by the user 275 to overcome the holding force is substantially the same to move the door 36, 40, 42, 44 in either one of the opening direction and the closing direction.

Referring to FIG. 8 and according to further aspects of the disclosure, the method can include the step of 1400 detecting no motion of the one of the plurality of doors 36, 40, 42, 44 at a steady state using at least one of a plurality of position sensors 48 disposed on each of the plurality of doors 36, 40, 42, 44 and configured to detect a position of the one of the plurality of doors 36, 40, 42, 44 associated therewith. The method continues with the step of 1402 monitoring an electrical current of the electric motor 181 during the steady state. The method proceeds by 1404 detecting motion of the one of the plurality of doors 36, 40, 42, 44. Next, 1406 storing the electrical current of the electric motor 181 at a position of the one of the plurality of doors 36, 40, 42, 44 at a moment the one of the plurality of doors 36, 40, 42, 44 is detected to move in the opening direction. In addition, the method includes the step of 1408 storing the electrical current of the electric motor 181 at another position of the door 36, 40, 42, 44 at another moment the one of the plurality of doors 36, 40, 42, 44 is detected to move in the closing direction. The method further includes the step of 1410 using the electrical current of the electric motor 181 at the position of the one of the plurality of doors 36, 40, 42, 44 at the moment the one of the plurality of doors 36, 40, 42, 44 is detected to move in the opening direction and the electrical current of the electric motor 181 at the another position of the one of the plurality of doors 36, 40, 42, 44 at the another moment the one of the plurality of doors 36, 40, 42, 44 is detected to move in the closing direction, calculating a mid holding current at positions of the one of the plurality of doors 36, 40, 42, 44 between the electrical current of the electric motor 181 at the position of the one of the plurality of doors 36, 40, 42, 44 at the moment the one of the plurality of doors 36, 40, 42, 44 is detected to move in the opening direction and the electrical current of the electric motor 181 at the another position of the one of the plurality of doors 36, 40, 42, 44 at the another moment the one of the plurality of doors 36, 40, 42, 44 is detected to move in the closing direction. The method additionally includes the step of 1412 adjusting the holding current to a balanced holding current or target holding current (I_hold_target) equal to the mid holding current. The method also includes the step of 1414 using the balanced holding current to control the electric motor 181 of the power actuator 35 to hold the one of the plurality of doors 36, 40, 42, 44.

According to further aspects, the method can also include the step of adapting the holding force of the power actuator 35 over time based on an actual monitored behavior of the door 36, 40, 42, 44 moving out of the holding position. The method may additionally include the step of adjusting the holding current in a powered assist mode and not in an automatic mode.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “controller” as used in this application is comprehensive of any such computer, processor, microchip processor, integrated circuit, or any other element(s), whether singly or in multiple parts, capable of carrying programming for performing the functions, methods and flowcharts provided herein. The controller may be a single such element which is resident on a printed circuit board with the other electronic elements. It may, alternatively, reside remotely from the other elements systems described herein. For example, but without limitation, the at least one controller may take the form of programming in the onboard computer of a vehicle within the door, a latch or at other locations within the vehicle as examples. The controller may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, microcontroller, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

What is claimed is:

1. A power closure system for a vehicle comprising:
a door;
a power actuator for moving the door between closed and open positions, wherein the power actuator is adapted to output a holding force to hold the door at a hold position between a closed position and an open position; and
the power actuator configured to output the holding force such that a force applied to the door by a user to overcome the holding force is substantially the same to move the door in either one of an opening direction and a closing direction.

2. The power closure system as set forth in claim 1, further including at least one controller coupled to the power actuator, the at least one controller having a memory device storing a predetermined door system model, and the at least one controller is configured to:
calculate a holding current to be applied to the power actuator to maintain the door in the hold positon using the predetermined door system model; and
adjust the holding current to a balanced holding current to provide the holding force such that the force applied to the door by the user to overcome the holding force is substantially the same to move the door in either one of the opening direction and the closing direction.

3. The power closure system as set forth in claim 1, wherein the door includes a plurality of doors and the system further includes at least one controller and a plurality of position sensors each disposed on one of the plurality of doors and coupled to the at least one controller and configured to detect a position of the one of the plurality of doors associated therewith, wherein the power actuator includes an electric motor, and the at least one controller is configured to:
detect no motion of the one of the plurality of doors at a steady state using at least one of the plurality of position sensors;
monitor an electrical current of the electric motor during the steady state; and
detect motion of the one of the plurality of doors.

4. The power closure system as set forth in claim 3, wherein the at least one controller is further configured to:
store the electrical current of the electric motor at a position of the one of the plurality of doors at a moment the one of the plurality of doors is detected to move in the opening direction;
store the electrical current of the electric motor at another position of the one of the plurality of doors at another moment the one of the plurality of doors is detected to move in the closing direction; and
use the electrical current of the electric motor at the position of the one of the plurality of doors at the moment the one of the plurality of doors is detected to move in the opening direction and the electrical current of the electric motor at the another position of the one of the plurality of doors at the another moment the one of the plurality of doors is detected to move in the closing direction, calculate a mid holding current at positions of the one of the plurality of doors between the electrical current of the electric motor at the position of the one of the plurality of doors at the moment the one of the plurality of doors is detected to move in the opening direction and the electrical current of the electric motor at the another position of the one of the plurality of doors at the another moment the one of the plurality of doors is detected to move in the closing direction.

5. The power closure system as set forth in claim 4, wherein the at least one controller is further configured to:
adjust the holding current to a balanced holding current equal to the mid holding current; and
use the balanced holding current to control the electric motor of the power actuator to hold the one of the plurality of doors.

6. The power closure system as set forth in claim 1, wherein the holding force of the power actuator is adapted over time based on an actual monitored behavior of the door moving out of the holding position.

7. The power closure system as set forth in claim 2, wherein the at least one controller is configured to adjust the holding current in a powered assist mode and not in an automatic mode.

8. A power closure system for a vehicle comprising:
a door;
a power actuator for moving the door between closed and open positions, the power actuator operated using a predetermined door system model; and
wherein the operation of the power actuator using the predetermined door system model is adapted based on an actual monitored behavior of the door during a manual movement of the door by a user.

9. The power closure system as set forth in claim 8, further including at least one controller coupled to the power actuator, the at least one controller having a memory device storing the predetermined door system model, and the at least one controller is configured to:
calculate a holding current to be applied to the power actuator to maintain the door in a hold positon using the predetermined door system model; and
adjust the holding current to a balanced holding current to provide the holding force such that a force applied to the door by the user to overcome the holding force is substantially the same to move the door in either one of the opening direction and the closing direction.

10. The power closure system as set forth in claim 8, wherein the door includes a plurality of doors and the system further includes at least one controller and a plurality of position sensors each disposed on one of the plurality of doors and coupled to the at least one controller and configured to detect a position of the one of the plurality of doors associated therewith, wherein the power actuator includes an electric motor, and the at least one controller is configured to:
detect no motion of the one of the plurality of doors at a steady state using at least one of the plurality of position sensors;
monitor an electrical current of the electric motor during the steady state; and
detect motion of the one of the plurality of doors.

11. The power closure system as set forth in claim 10, wherein the at least one controller is further configured to:
store the electrical current of the electric motor at a position of the one of the plurality of doors at a moment the one of the plurality of doors is detected to move in the opening direction;
store the electrical current of the electric motor at another position of the one of the plurality of doors at another moment the one of the plurality of doors is detected to move in the closing direction; and
use the electrical current of the electric motor at the position of the one of the plurality of doors at the moment the one of the plurality of doors is detected to move in the opening direction and the electrical current of the electric motor at the another position of the one of the plurality of doors at the another moment the door is detected to move in the closing direction, calculate a mid holding current at positions of the one of the plurality of doors between the electrical current of the electric motor at the position of the one of the plurality of doors at the moment the one of the plurality of doors is detected to move in the opening direction and the electrical current of the electric motor at the another position of the one of the plurality of doors at the another moment the one of the plurality of doors is detected to move in the closing direction.

12. The power closure system as set forth in claim 11, wherein the at least one controller is further configured to:
adjust the holding current to a balanced holding current equal to the mid holding current; and
use the balanced holding current to control the electric motor of the power actuator to hold the one of the plurality of doors.

13. The power closure system as set forth in claim 12, wherein the power actuator is adapted to output a holding force to hold the one of the plurality of doors at a hold position between a closed position and an open position, and the holding force of the power actuator is adapted over time based on the actual monitored behavior of the one of the plurality of doors moving out of the holding position.

14. A method of operating a power closure system for a vehicle having a door, comprising the steps of:
moving the door between closed and open positions using a power actuator; and
outputting a holding force to hold the door at a hold position between a closed position and an open position using the power actuator, the holding force selected such that a force applied to the door by a user to overcome the holding force is substantially the same to move the door in either one of an opening direction and a closing direction.

15. The method as set forth in claim 14, further including:
storing a predetermined door system model in a memory device of at least one controller coupled to the power actuator;
calculating a holding current to be applied to the power actuator to maintain the door in the hold positon using the predetermined door system model; and
adjusting the holding current to a balanced holding current to provide the holding force such that the force applied to the door by the user to overcome the holding force is substantially the same to move the door in either one of the opening direction and the closing direction.

16. The method as set forth in claim 14, wherein the door includes a plurality of doors and the method further includes:
detecting no motion of one of the plurality of doors at a steady state using at least one of a plurality of position sensors disposed on each of the plurality of doors and configured to detect a position of the one of the plurality of doors associated therewith;
monitoring an electrical current of an electric motor of the power actuator during the steady state; and
detecting motion of the one of the plurality of doors.

17. The method as set forth in claim 16, further including:
storing the electrical current of the electric motor at a position of the one of the plurality of doors at a moment the one of the plurality of doors is detected to move in the opening direction;
storing the electrical current of the electric motor at another position of the one of the plurality of doors at another moment the one of the plurality of doors is detected to move in the closing direction; and
using the electrical current of the electric motor at the position of the one of the plurality of doors at the moment the one of the plurality of doors is detected to move in the opening direction and the electrical current of the electric motor at the another position of the one of the plurality of doors at the another moment the door is detected to move in the closing direction, calculating a mid holding current at positions of the one of the plurality of doors between the electrical current of the electric motor at the position of the door at the moment the one of the plurality of doors is detected to move in the opening direction and the electrical current of the electric motor at the another position of the one of the plurality of doors at the another moment the one of the plurality of doors is detected to move in the closing direction.

18. The method as set forth in claim 17, further including:
adjusting the holding current to a balanced holding current equal to the mid holding current; and
using the balanced holding current to control the electric motor of the power actuator to hold the one of the plurality of doors.

19. The method as set forth in claim 14, further including adapting the holding force of the power actuator over time based on an actual monitored behavior of the door moving out of the holding position.

20. The method as set forth in claim 15, further including adjusting the holding current in a powered assist mode and not in an automatic mode.
